(19) United States
(12) Patent Application Publication
(10) Pub. No.: US 2018/0163598 A1
(43) Pub. Date: Jun. 14, 2018

(54) SCR CATALYTIC SYSTEM

(71) Applicant: TOYOTA JIDOSHA KABUSHIKI KAISHA, Toyota-shi (JP)

(72) Inventors: Tomoyuki MIZUNO, Miyoshi-shi (JP); Koji TSUKAMOTO, Kasugai-shi (JP)

(73) Assignee: TOYOTA JIDOSHA KABUSHIKI KAISHA, Toyota-shi (JP)

(21) Appl. No.: 15/833,462

(22) Filed: Dec. 6, 2017

(30) Foreign Application Priority Data
Dec. 9, 2016 (JP) 2016-239367

(51) Int. Cl. F01N 3/28; B01D 53/94; F01N 3/20

(52) U.S. Cl. CPC F01N 3/2803; B01D 53/9418; B01D 2255/2047; B01D 2255/50; B01D 2255/20761; F01N 3/2066

(57) ABSTRACT

According to the present disclosure, there is provided an SCR catalytic system including an SCR catalyst that absorbs NH₃ and reduces NOx using the absorbed NH₃ as a reducing agent. In the SCR catalytic system, the SCR catalyst is a Cu- and Mg-containing CHA zeolite in which a silica-alumina ratio (SiO₂/Al₂O₃ molar ratio) is 10 to 13 and 0.18 weight % to 0.44 weight % of Mg is contained.

### INCORPORATION BY REFERENCE

The disclosure of Japanese Patent Application No. 2016-239367 filed on Dec. 9, 2016 including the specification, drawings and abstract is incorporated herein by reference in its entirety.

### BACKGROUND

### 1. Technical Field

The present disclosure relates to an SCR catalytic system including an SCR catalyst.

### 2. Description of Related Art

A selective reduction type NOx catalyst (hereinafter referred to as a “selective catalytic reduction (SCR) catalyst”) which selectively reduces nitrogen oxides (NOx) as harmful components contained in exhaust gas discharged from internal combustion engines has been widely exploited in the related art. In general, an SCR catalyst utilizes ammonia (NH₃) to cause NOx and NH₃ to selectively react with each other and decompose into nitrogen (N₂) and water (H₂O).

It is known that a zeolite catalyst containing copper, iron, and the like can be used as the SCR catalyst. For example, in Japanese Unexamined Patent Application Publication (Translation of PCT Application) No. 2015-533343 (JP 2015-533343 A), a catalyst for selective catalytic reduction containing a small pore molecular sieve containing 8-membered rings facilitated by copper and an alkaline earth component is described, and a small pore molecular sieve containing 8-membered rings that is a chabazite (CHA) type zeolite is described.

In addition, an exhaust gas control apparatus in which an SCR catalytic system is disposed in a rear stage of a three-way catalyst or an NOx storage reduction catalyst, control for appropriately switching an air-fuel ratio of an exhaust gas to a lean air-fuel ratio or a rich air-fuel ratio is performed, and thus NH₃ is supplied to the SCR catalytic system in the rear stage and NOx is removed is known (for example, refer to Japanese Patent No. 3456408 (JP 3456408 B) and Japanese Patent No. 4924217 (JP 4924217 B)).

However, in the SCR catalyst of the related art using zeolite, for example, when an amount of aluminum (Al) contained in the zeolite catalyst is small as in a case in which a silica-alumina ratio (SiO₂/Al₂O₃ molar ratio) exceeds 15, since the number of acid sites having an NH₃ adsorption function is decreased, an NH₃ adsorbing ability of the catalyst is lowered. As a result, NOx removal performance of the catalyst deteriorates. In particular, sufficient NOx removal performance is not obtained in a transient environment in which NH₃ is not constantly supplied, for example, in a case in which fuel is temporarily injected, a rich combustion state is brought about, and NH₃ generated at this time is used.

### SUMMARY

As described above, in the SCR catalytic system of the related art, when a zeolite catalyst is used as the SCR catalyst, if an amount of Al in the zeolite catalyst is small, sufficient NOx removal performance may not be obtained depending on the usage environment. Therefore, the present disclosure provides an SCR catalytic system including an SCR catalyst having sufficient NOx removal performance in a transient environment in which NH₃ is not constantly supplied.

The inventors found that, when a Cu- and Mg-containing CHA type zeolite is used as an SCR catalyst, and additionally a silica-alumina ratio (SiO₂/Al₂O₃ molar ratio) and a content of Mg are specified, the SCR catalyst can exhibit sufficient NOx removal performance in a transient environment in which NH₃ is not constantly supplied, and completed the present disclosure.

An aspect of the present disclosure relates to an SCR catalytic system including an SCR catalyst that absorbs NH₃ and reduces NOx using the absorbed NH₃ as a reducing agent. The SCR catalyst is a Cu- and Mg-containing CHA zeolite in which the silica-alumina ratio (SiO₂/Al₂O₃ molar ratio) is 10 to 13, and which contains 0.18 weight % to 0.44 weight % of Mg. NH₃ generated when fuel is temporarily injected into an engine such that a combustion state of the engine becomes a rich state may be used as a reducing agent of the SCR catalyst.

According to the present disclosure, it is possible to provide an SCR catalytic system including an SCR catalyst having sufficient NOx removal performance in a transient environment in which NH₃ is not constantly supplied.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing the relationship between a content of Mg and an NOx removal proportion of catalysts having a predetermined SAR value; and

FIG. 2 is a diagram showing the relationship between an SAR and an NOx removal proportion of catalysts having a predetermined content value of Mg.

### DETAILED DESCRIPTION OF EMBODIMENTS

Embodiments of the present disclosure will be described below in detail.

An embodiment of the present disclosure relates to an SCR catalytic system including a CHA type zeolite containing copper (Cu) and magnesium (Mg) as an SCR catalyst.

<Scr Catalyst>

The SCR catalyst used in the SCR catalytic system of the embodiment of the present disclosure absorbs NH₃ and reduces NOx using the absorbed NH₃ as a reducing agent. Specifically, the SCR catalyst causes NOx and NH₃ to selectively react with each other and decompose into N₂ and H₂O and thus reduces NOx.

The SCR catalyst of the present embodiment is a Cu- and Mg-containing CHA type zeolite.

The zeolite used in the catalyst of the present embodiment is a zeolite (hereinafter referred to as a “CHA type zeolite” or simply referred to as a “zeolite”) is an aluminosilicate having a crystal structure that is a CHA structure. A CHA type zeolite is a zeolite having the same crystal structure as naturally occurring chabazite, and CHA is a code that specifies the structure of the zeolite as defined by the International Zeolite Association (IZA).

Examples of the CHA type zeolite include SSZ-13 and SAPO-34.

In the catalyst of the present embodiment, the zeolite has a silica-alumina ratio (SiO₂/Al₂O₃ molar ratio; SAR) of 10 to 13. When the SAR is 10 to 13, sufficient structural stability and durability are maintained and high NOx removal performance is obtained. The SAR of the zeolite can be measured using fluorescent X-ray analysis (XRF).

In the catalyst of the present embodiment, the zeolite contains Cu and Mg. In the catalyst of the present embodiment, Cu and Mg are considered to be supported on the zeolite as extra-framework metals by ion exchange. That is, the zeolite is considered to contain Cu and Mg inside the zeolite and/or on at least a part of the surface of the zeolite, preferably as ionic species. When the zeolite contains Cu, NOx and NH₃ come close to each other and there is greater reaction therebetween. Thus, they can be decomposed into N₂ and H₂O. In addition, when the zeolite contains Mg, Mg protects acid sites which serve as adsorption sites of water in the zeolite, and absorption of water to acid sites can be prevented. Thereby, dealumination can be prevented, and accordingly structural stability is improved and catalyst performance is stabilized.

In the catalyst of the present embodiment, a content of Mg in the zeolite is 0.18 weight % to 0.44 weight % (with respect to the total weight of the zeolite). When the content of Mg is 0.18 weight % to 0.44 weight %, NOx removal performance of the catalyst significantly increases. Here, when the content of Mg in the zeolite exceeds 0.44 weight %, an amount of NH₃ absorbed decreases, and NOx removal performance of the catalyst deteriorates.

The present embodiment provides an unexpected effect of significantly increasing NOx removal performance of the catalyst due to setting the silica-alumina ratio and the content of Mg to be in specific ranges in the Cu- and Mg-containing CHA type zeolite catalyst. This effect is speculated to be as follows. That is, in a zeolite catalyst, since the number of acid sites having an NH₃ adsorption function increases when the silica-alumina ratio decreases, although catalyst performance increases, structural stability is lowered due to dealumination caused by absorption of water to acid sites and catalyst performance deteriorates. When the zeolite contains Mg, acid sites can be protected. However, when the content of Mg is too large, an NH₃ adsorbing ability is lowered. In the present embodiment, when the silica-alumina ratio of the zeolite and the content of Mg are set to be in specific ranges, it is possible to optimize the NOx removal performance of the catalyst while maintaining structural stability.

In the catalyst of the present embodiment, a content of Cu in the zeolite is preferably 1.7 weight % to 3.6 weight % and more preferably 1.8 weight % to 3.4 weight %. When the content of Cu is 1.7 weight % to 3.6 weight %, NOx removal performance is improved. Here, the content of Cu in the zeolite is preferably adjusted according to the silica-alumina ratio (SAR). For example, when the SAR is 10 or more and less than 11, the content of Cu is preferably 1.7 or more and less than 3.6. When the SAR is 11 or more and less than 12, the content of Cu is preferably 1.7 or more and less than 3.3. When the SAR is 12 or more and 13 or less, the content of Cu is preferably 1.7 or more and less than 3.1.

In the catalyst of the present embodiment, the average particle size of the zeolite is preferably 0.3 μm to 6.0 μm, more preferably 0.5 μm to 5.0 μm, and most preferably 0.7 μm to 4.0 μm. When a honeycomb catalyst is produced using a zeolite having such an average particle size, it is possible to increase the pore size (pore size of macropores inside partition walls) of the honeycomb unit, it is possible to reduce capillary stress during water absorption, and furthermore, it is possible to improve NOx removal performance by gas diffusion. The average particle size of the zeolite is an average particle size of primary particles measured with a scanning electron microscope (SEM).

In consideration of a crystal structure, the specific surface area of the zeolite used in the catalyst of the present embodiment is preferably 500 m²/g to 750 m²/g and more preferably 550 m²/g to 700 m²/g.

<Method of Producing SCR Catalyst>

The catalyst of the present embodiment can be produced by a general method without particular limitations. For example, the catalyst of the present embodiment may be obtained by preparing a CHA type zeolite and introducing Cu and Mg into the CHA type zeolite.

The zeolite is obtained by reacting a raw material composition including an Si source, an Al source, an alkali source, and a structure directing agent.

The Si source refers to a compound, a salt, or a composition which are raw materials of a silicon component of the zeolite. As the Si source, for example, colloidal silica, amorphous silica, sodium silicate, tetraethylorthosilicate, and an aluminosilicate gel can be used, and two or more thereof can be used in combination. Among them, colloidal silica is preferable because a zeolite having a relatively large particle size can be obtained.

The Al source refers to a compound, a salt, or a composition which are raw materials of an aluminum component of the zeolite. As the Al source, for example, a dried aluminum hydroxide gel can be used.

In the method of producing a zeolite of the present embodiment, in order to produce a CHA type zeolite having a desired composition, the silica-alumina ratio (SiO₂/Al₂O₃ molar ratio) in the raw material composition is preferably 5 to 50 and more preferably 8 to 30.

As the alkali source, for example, sodium hydroxide, potassium hydroxide, rubidium hydroxide, cesium hydroxide, lithium hydroxide, an alkaline component in aluminates and silicates, and an alkaline component in an aluminosilicate gel can be used, and two or more thereof may be used in combination. Among them, potassium hydroxide and sodium hydroxide are preferable because a zeolite having a relatively large particle size can be obtained.

The structure directing agent (SDA) refers to an organic molecule that regulates the pore size and the crystal structure of the zeolite. According to the type of the structure directing agent and the like, it is possible to control the structure of the obtained zeolite and the like. As the structure directing agent, at least one selected from the group consisting of a hydroxide, a halide, a carbonate, a methyl carbonate salt, sulfates and nitrates including N,N,N-trialkyladamantane ammonium as a cation may be exemplified; and a hydroxide, a halide, a carbonate, a methyl carbonate salt, and sulfates and nitrates having an N,N,N-trimethylbenzylammonium ion, an N-alkyl-3-quinuclidinol ion, or N,N,N-trialkylexoaminonorbornane as a cation can be used. Among them, at least one selected from the group consisting of N,N,N-trimethyladamantaneammonium hydroxide (TMAAOH), an N,N,N-trimethyladamantaneammonium halide, an N,N,N-trimethyladamantaneammonium carbonate, an N,N,N-trimethyladamantaneammonium methyl carbonate salt, and an N,N,N-trimethyladamantaneammonium sulfate is preferable, and TMAAOH is more preferably used.

In the method of producing a zeolite, in order to produce a desired CHA type zeolite, the SDA/SiO₂ molar ratio in the raw material composition is preferably 0.05 to 0.40 and more preferably 0.08 to 0.25.

In the method of producing a zeolite, it is preferable that a seed crystal of the zeolite be additionally added to the raw material composition. When the seed crystal is used, a crystallization rate of the zeolite increases, a time for zeolite production can be shortened and a yield is improved. As the seed crystal of the zeolite, a seed crystal of aluminosilicate having a CHA structure is preferably used. The silica-alumina ratio in the seed crystal of the zeolite is preferably 5 to 50 and more preferably 8 to 30. An amount of the zeolite seed crystal added is preferably small. However, in consideration of a reaction rate, an impurity reduction effect, and the like, the amount is preferably 0.1 weight % to 20 weight % and more preferably 0.5 weight % to 15 weight % with respect to the silica component included in the raw material composition.

In the method of producing a zeolite, regardless of the presence of the zeolite seed crystal, it is preferable that water be additionally added to the raw material composition.

In the method of producing a zeolite, the prepared raw material composition is reacted to synthesize a zeolite. Specifically, it is preferable to synthesize a zeolite by hydrothermal synthesis of the raw material composition.

A reaction container used for hydrothermal synthesis is not particularly limited as long as it is used for known hydrothermal synthesis, and a heat and pressure resistant container such as an autoclave may be used. When the raw material composition is put into a reaction container, which is then sealed and heated, the zeolite can be crystallized.

When the zeolite is synthesized, the raw material mixture may be in a stationary state, but is preferably in a state of being stirred and mixed.

In consideration of the yield and impurity reduction, a heating temperature when the zeolite is synthesized is preferably 100° C. to 200° C. and more preferably 120° C. to 180° C.

In consideration of the yield and costs, a heating time when the zeolite is synthesized is preferably 10 hours to 200 hours.

A pressure when the zeolite is synthesized is not particularly limited. A pressure generated when the raw material composition put into the sealed container is heated to the above temperature range is sufficient. However, as necessary, an inert gas such as nitrogen gas may be added to increase the pressure.

In the method of producing a zeolite, after the zeolite is synthesized, preferably, the zeolite is sufficiently cooled, subjected to solid-liquid separation, washed with a sufficient amount of water, and dried. A drying temperature is not particularly limited, and may be an arbitrary temperature of 100° C. to 150° C.

Since the synthesized zeolite may contain the SDA and/or alkali metals in pores, these may be removed as necessary. The SDA and/or alkali metals can be removed by, for example, a liquid phase treatment using an acidic solution or a chemical solution including an SDA decomposing component, an exchange treatment using a resin and the like, or a pyrolysis treatment.

Through the above processes, the CHA type zeolite can be produced. Analysis of the crystal structure of the zeolite can be performed using an X-ray diffractometer (XRD).

Cu can be introduced into the CHA type zeolite by, for example, immersing a zeolite in a Cu ion-containing aqueous solution and performing ion exchange with Cu ions. As the Cu ion-containing aqueous solution, for example, a copper nitrate aqueous solution of about 40 weight % to 70 weight % and a copper acetate aqueous solution of about 5 weight % to 20 weight % can be used. An immersion time is about 0.1 hours to 2 hours. An immersion temperature is room temperature to about 50° C. The concentration and the immersion time in the Cu ion aqueous solution are adjusted according to the content of Cu in a desired zeolite.

Mg can be introduced into the CHA type zeolite by, for example, adding a zeolite to an Mg ion-containing aqueous solution and performing ion exchange with Mg ions. For example, a zeolite may be added to a magnesium nitrate aqueous solution with a predetermined concentration to prepare a slurry, and the obtained slurry may be dried, and then calcined at a high temperature (for example, 500° C. to 800° C.). The concentration of the Mg ion-containing aqueous solution is adjusted according to the content of Mg in a desired zeolite.

The order of introducing Cu and Mg into the zeolite is not particularly limited. However, preferably, Cu is introduced into the zeolite, and Mg is introduced into the obtained zeolite containing Cu.

The catalyst of the present embodiment may be a so-called pellet type catalyst, and generally, a monolith type catalyst in which a catalyst is washcoated on a carrier substrate may be used. As a method of producing a monolith type catalyst, a known method can be used. As the carrier substrate, a known base material used in an exhaust gas removal catalyst can be used. For example, a honeycomb substrate made of a ceramic material having heat resistance such as cordierite, alumina, zirconia, or silicon carbide or a metal such as stainless steel is preferably used. A cordierite honeycomb having excellent heat resistance and a low coefficient of thermal expansion is particularly preferably used. The honeycomb substrate preferably includes a plurality of cells having both ends that are open. In this case, the cell density of the honeycomb substrate is not particularly limited. A so-called medium density honeycomb substrate of about 200 cells per square inch or a so-called high density honeycomb substrate of 1000 cells per square inch or more is preferably used. The cross-sectional shape of the cell is not particularly limited, and may be a circle, a rectangle, a hexagon, or the like. The honeycomb catalyst of the present embodiment preferably contains 100 g to 200 g of the zeolite per liter of bulk volume of the carrier substrate.

<SCR Catalytic System>

The SCR catalytic system of the present embodiment includes the SCR catalyst.

In the SCR catalytic system of the present embodiment, the SCR catalyst absorbs NH₃, and reduces NOx using the absorbed NH₃ as a reducing agent.

NH₃ is generally generated in a system disposed in a front stage of the SCR catalytic system. For example, when an NH₃ generation unit is provided in the front stage of the SCR catalytic system of the present embodiment, NH₃ is generated. As an embodiment, for example, as described in JP 3456408 B and JP 4924217 B, a case in which the SCR catalytic system is disposed in the rear stage of a three-way catalyst and/or an NOx storage reduction catalyst in an exhaust gas passage of an internal combustion engine may be exemplified. In the embodiment, the three-way catalyst and/or the NOx storage reduction catalyst can be regarded as the NH₃ generation unit, and when an exhaust gas passes through the three-way catalyst and/or the NOx storage reduction catalyst, NOx in the exhaust gas reacts with HC or H₂, and NH₃ is generated. Particularly, when the air-fuel ratio of the exhaust gas that passes through the three-way catalyst and/or the NOx storage reduction catalyst is equal to or less than a stoichiometric air-fuel ratio, NH₃ is generated. The generated NH₃ is introduced into the SCR catalytic system in the rear stage, the SCR catalyst absorbs NH₃, and decomposes NOx into N₂ and H₂O using the absorbed NH₃ as a reducing agent, and performs reduction. As the three-way catalyst and the NOx storage reduction catalyst, known catalysts described in JP 3456408 B and JP 4924217 B can be used.

Therefore, in the embodiment of the present embodiment, the SCR catalytic system of the present embodiment is used for a catalytic system disclosed in JP 3456408 B and JP 4924217 B.

The SCR catalytic system of the present embodiment is particularly effectively used in a transient environment in which NH₃ is not constantly supplied but NH₃ is temporarily supplied because the SCR catalyst has a high NH₃ adsorbing ability and NOx removal performance is optimized. As such a mode of use, for example, a mode in which, when fuel is temporarily injected into an internal combustion engine (rich spike) such that an combustion state of the internal combustion engine becomes a rich state, and NH₃ generated at this time is used as a reducing agent of the SCR catalyst may be exemplified. The rich spike can be performed by an operation of a control device configured to change an operation state of an internal combustion engine, for example, as described in JP 3456408 B and JP 4924217 B. Thus, in the embodiment of the present disclosure, in the SCR catalytic system of the present embodiment, when fuel is temporarily injected, a rich combustion state is brought about, and NH₃ generated at this time is used as a reducing agent of the SCR catalyst. The SCR catalytic system of the present embodiment can exhibit extremely high NOx removal performance even in conditions in which the SCR catalyst of the related art fails to obtain sufficient NOx removal performance.

The present disclosure will be described below in further detail with reference to examples. However, the technical scope of the present disclosure is not limited to the following examples.

<Preparation of Cu-Containing CHA Type Zeolite>

### Preparation of Sample 1

A Cu-containing CHA type zeolite in which a content of Cu was 2.5 weight % and a silica-alumina ratio (SiO₂/Al₂O₃ molar ratio; SAR) was 10 was prepared as follows.

Specifically, colloidal silica (SNOWTEX 30 commercially available from Nissan Chemical Industries, Ltd.) as an Si source, a dried aluminum hydroxide gel (commercially available from Strem Chemicals) as an Al source, potassium hydroxide (commercially available from Toagosei Co., Ltd.) as an alkali source, a 25% aqueous solution of N,N,N-trimethyladamantaneammonium hydroxide (TMAAOH) (commercially available from Sachem) as a structure directing agent (SDA), SSZ-13 (SAR=30, commercially available from BASF) as a seed crystal, and deionized water were mixed together to prepare a raw material composition. The molar ratio of the raw material composition was SiO₂:10 mol, Al₂O₃:1.0 mol, K₂O:3.0 mol, TMAAOH:2.4 mol, and H₂O:390 mol. In addition, the seed crystal was added in a proportion of 5 weight % with respect to a total amount of silica, alumina, and potassium oxide in the raw material composition.

The raw material composition was loaded into a 200 mL autoclave and subjected to hydrothermal synthesis (a stirring speed of 10 rpm, a heating temperature of 160° C., and a heating time of 24 hours) to synthesize a zeolite.

The obtained zeolite was immersed in a copper nitrate aqueous solution (65 weight %) at room temperature for 1 hour. Thus, a Cu-containing CHA type zeolite (Sample 1) in which a content of Cu was 2.5 weight % and the SAR was 10 was prepared.

Here, the SAR and the content of Cu of the obtained Cu-containing CHA type zeolite were measured by ICP-OES (high-frequency inductively-coupled plasma emission spectroscopic analyzer, ICPV-8100, commercially available from Shimadzu Corporation) as follows.

Specifically, 100 mg of the sample was acquired, a predetermined amount of a dissolution agent was added, and it was dissolved at 1000° C. The obtained dissolved material was cooled to room temperature. Then, a predetermined amount of a hydrochloric acid solution was added and heating was performed at about 80° C. to completely dissolve the sample. The obtained solution was cooled to room temperature and pure water was then added so that a total amount was 100 ml. According to ICP-OES, contents of Cu, Si, and Al in the solution were measured. Based on the contents of Cu, Si, and Al and the weight of the acquired sample, weight percent concentrations of Cu, Si, and Al were calculated and the SiO₂/Al₂O₃ molar ratio (SAR) of the zeolite was calculated.

Preparation of Samples 2 to 5

Cu-containing CHA type zeolites (referred to as Samples 2, 3, 4, and 5) in which the SAR was 13, 15, 22, and 44 were prepared in the same manner as in Sample 1 except that amounts of colloidal silica and a dried aluminum hydroxide gel were changed and the molar ratio of the raw material composition was adjusted to predetermined values. Specifically, samples were prepared to have a molar ratio of the raw material composition such that Sample 2 having an SAR of 13 had SiO₂: 13 mol and Al₂O₃: 1 mol, Sample 3 having an SAR of 15 had SiO₂: 15 mol and Al₂O₃: 1 mol, Sample 4 having an SAR of 22 had SiO₂: 22 mol and Al₂O₃: 1 mol, and Sample 5 having an SAR of 44 had SiO₂: 44 mol and Al₂O₃: 1 mol.

<Preparation of Cu- and Mg-Containing CHA Type Zeolite>

Mg was introduced into the obtained Cu-containing CHA type zeolites (Samples 1 to 5) having different SARs to prepare Cu- and Mg-containing CHA type zeolites of Examples 1 to 6 and Comparative Examples 2, 4, 6 to 9, 11 to 14 and 16 to 19.

### Example 1

An amount of magnesium nitrate hexahydrate to be added so that a content of Mg became 0.2 weight % with respect to 1100 g of a sample having an SAR of 10 was computed. A predetermined amount of magnesium nitrate hexahydrate obtained by computation was dissolved in water (600 ml) to prepare a magnesium nitrate aqueous solution. Here, 1100 g of the sample was added to the prepared magnesium nitrate aqueous solution to obtain a slurry, and the obtained slurry was stirred under a reduced pressure and in a high temperature environment of 80° C. to remove moisture in the slurry. The generated cake was dried at 120° C. and was then calcined at 700° C. for 2 hours to obtain a Cu- and Mg-containing CHA type zeolite. In the same manner as in the measurement of contents of Cu, Si, and Al, when a content of Mg in the sample was measured by ICP-OES, the content of Mg was 0.18 weight % (with respect to the weight of the Cu- and Mg-containing CHA type zeolite).

### Examples 2 and 3 and Comparative Example 2

Cu- and Mg-containing CHA type zeolites of Examples 2 and 3 and Comparative Example 2 in which the SAR was 10 and the content of Mg was 0.29, 0.44, and 0.58 weight % (actual measurement value) were prepared in the same manner as in Sample 1 except that the concentration of the magnesium nitrate aqueous solution was changed so that the content of Mg was 0.3, 0.45, and 0.6 weight %.

### Examples 4 to 6 and Comparative Example 4

Cu- and Mg-containing CHA type zeolites of Examples 4, 5, and 6 and Comparative Example 4 in which the SAR was 13 and the content of Mg was 0.18, 0.29, 0.44, and 0.58 weight % (actual measurement value) were prepared in the same manner as in Sample 1 except that a magnesium nitrate aqueous solution having a concentration at which the content of Mg became 0.2, 0.3, 0.45, and 0.6 weight % was added to Sample 2 (SAR=13).

### Comparative Examples 6 to 9

Cu- and Mg-containing CHA type zeolites of Comparative Examples 6, 7, 8, and 9 in which the SAR was 15 and the content of Mg was 0.18, 0.29, 0.44, and 0.58 weight % (actual measurement value) were prepared in the same manner as in Sample 1 except that a magnesium nitrate aqueous solution having a concentration at which the content of Mg became 0.2, 0.3, 0.45, and 0.6 weight % was added to Sample 3 (SAR=15).

### Comparative Examples 11 to 14

Cu- and Mg-containing CHA type zeolites of Comparative Examples 11, 12, 13, and 14 in which the SAR was 22 and the content of Mg was 0.18, 0.29, 0.44, and 0.58 weight % (actual measurement value) were prepared in the same manner as in Sample 1 except that a magnesium nitrate aqueous solution having a concentration at which the content of Mg became 0.2, 0.3, 0.45, and 0.6 weight % was added to Sample 4 (SAR=22).

### Comparative Examples 16 to 19

Cu- and Mg-containing CHA type zeolites of Comparative Examples 16, 17, 18, and 19 in which the SAR was 44 and the content of Mg was 0.18, 0.29, 0.44, and 0.58 weight % (actual measurement value) were prepared in the same manner as in Sample 1 except that a magnesium nitrate aqueous solution having a concentration at which the content of Mg became 0.2, 0.3, 0.45, and 0.6 weight % was added to Sample 5 (SAR=44).

Samples 1 to 5 (Cu-containing CHA type zeolites) containing no Mg were set as Comparative Examples 1, 3, 5, 10, and 15, respectively.

The SAR and the content of Mg of the catalysts of Examples 1 to 6 and Comparative Examples 1 to 19 are shown in the following Table 1.

<Tests>

Honeycomb catalysts were prepared using the catalysts of Examples 1 to 6 and Comparative Examples 1 to 19, and a durability test and performance evaluation were performed.

1. Preparation of Honeycomb Catalyst

The catalysts of Examples 1 to 6 and Comparative Examples 1 to 19, an SiO₂ sol (with a proportion of 13 g of an SiO₂ sol in terms of SiO₂ with respect to 167 g of the zeolite) and water were mixed and stirred to obtain a slurry. The obtained slurry was applied to a cordierite honeycomb at a coating amount of 180 g/L, dried at 150° C., and calcined at 550° C. for 2 hours in air to obtain a honeycomb catalyst.

The obtained honeycomb catalysts were subjected to a durability test, and the catalyst performance was then evaluated.

2. Durability Test

The durability test of the honeycomb catalyst was performed such that a rich gas (CO (2%)+H₂O (10%)) and a lean gas (O₂ (10%)+H₂O (10%)) were alternately switched between (the rich gas for 10 seconds and the lean gas for 60 seconds), and the catalysts were exposed thereto at 800° C. and a space velocity (SV) of 114,000 h⁻¹ for 5 hours.

3. Performance Evaluation

Test pieces (a catalyst size of 15 cc) were cut out from the honeycomb catalysts after the durability test, an SCR reaction was simulated using a model gas evaluation device, and transient evaluation was performed in a transient environment in which NH₃ was not constantly supplied.

Specifically, the catalyst test pieces were loaded into a fixed-bed flow type reactor, a rich gas (NO (150 ppm)+NH₃ (550 ppm)+H₂O (5%)) and a lean gas (O₂ (10%)+NO (50 ppm)+H₂O (5%)) were alternately switched between (the rich gas for 10 seconds and the lean gas for 60 seconds), and the catalysts were exposed thereto at 410° C. and a space velocity (SV) of 85,700 h⁻¹.

Using an NOx analyzer (6000FT, commercially available from HORIBA), an amount of NOx flowing into the catalyst and an amount of NOx flowing out from the catalyst were measured and the NOx removal proportion was calculated by the following formula.

NOx removal proportion (%)=[(amount of NOx flowing into the catalyst−amount of NOx flowing out from the catalyst)÷amount of NOx flowing into the catalyst]×100

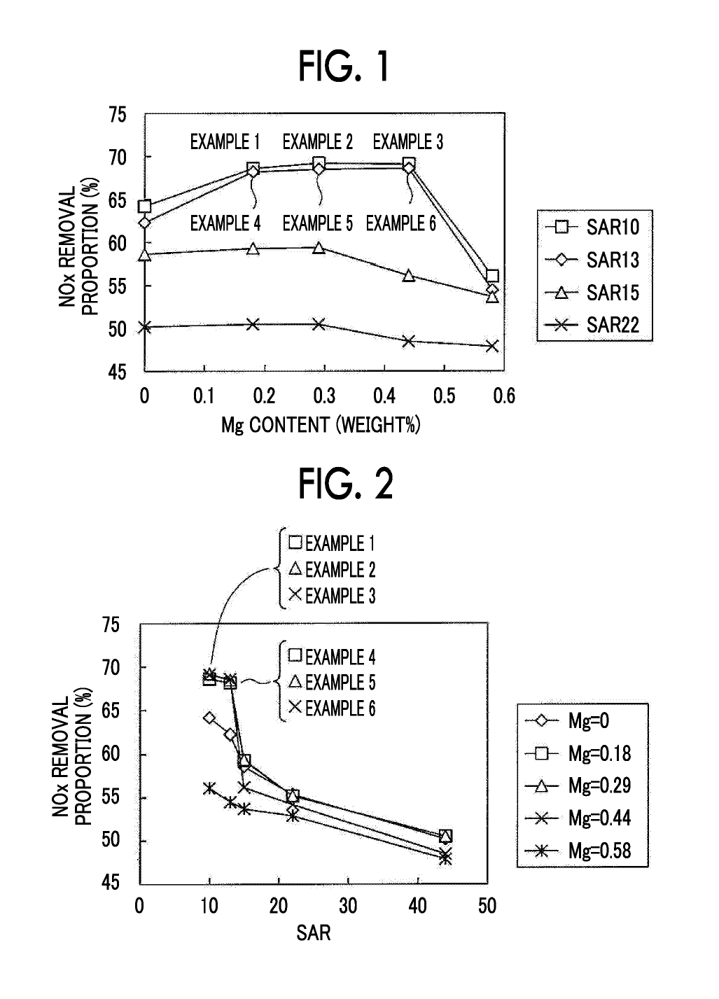

The results are shown in Table 1 and FIGS. 1 and 2. FIG. 1 is a diagram showing the relationship between the content of Mg and the NOx removal proportion of the catalysts having a predetermined SAR value. FIG. 2 is a diagram showing the relationship between the SAR and the NOx removal proportion of the catalysts having a predetermined content value of Mg. Here, the NOx removal proportion shown in FIG. 1 and FIG. 2 is the measurement value after the durability test.

TABLE 1

| | SAR (SiO₂/ | | |
|---|---|---|---|
| | Al₂O₃ molar | Mg content | NOₓ removal |
| | ratio) | (weight %) | proportion (%) |
| Example 1 | 10 | 0.18 | 68.6 |
| Example 2 | 10 | 0.29 | 69.2 |
| Example 3 | 10 | 0.44 | 69.1 |
| Example 4 | 13 | 0.18 | 68.2 |
| Example 5 | 13 | 0.29 | 68.5 |
| Example 6 | 13 | 0.44 | 68.6 |
| Comparative Example 1 | 10 | 0 | 64.2 (69.0) |
| Comparative Example 2 | 10 | 0.58 | 56.1 |
| Comparative Example 3 | 13 | 0 | 62.3 (68.5) |
| Comparative Example 4 | 13 | 0.58 | 54.5 |
| Comparative Example 5 | 15 | 0 | 58.6 (59.6) |
| Comparative Example 6 | 15 | 0.18 | 59.3 |
| Comparative Example 7 | 15 | 0.29 | 59.4 |
| Comparative Example 8 | 15 | 0.44 | 56.2 |
| Comparative Example 9 | 15 | 0.58 | 53.7 |
| Comparative Example 10 | 22 | 0 | 55.4 (55.6) |
| Comparative Example 11 | 22 | 0.18 | 55.2 |
| Comparative Example 12 | 22 | 0.29 | 55.2 |
| Comparative Example 13 | 22 | 0.44 | 54.2 |
| Comparative Example 14 | 22 | 0.58 | 52.9 |
| Comparative Example 15 | 44 | 0 | 50.2 (50.3) |
| Comparative Example 16 | 44 | 0.18 | 50.5 |
| Comparative Example 17 | 44 | 0.29 | 50.5 |
| Comparative Example 18 | 44 | 0.44 | 48.5 |
| Comparative Example 19 | 44 | 0.58 | 47.9 |

The value of the NOx removal proportion is the measurement value after the durability test, and the value in parentheses is the initial measurement value (before the durability test).

According to Table 1 and FIGS. 1 and 2, the SAR and the content of Mg have ranges in which the NOx removal proportion significantly increases. Specifically, the catalysts of Examples 1 to 6 in which the SAR was in a range of 10 to 13 and the content of Mg was in a range of 0.18 weight % to 0.44 weight % had a NOx removal proportion that was significantly higher and a catalyst performance that was improved over those of Comparative Examples 1 to 19 in which the SAR and the content of Mg were not in such ranges. The reason for this is speculated to be as follows. In the catalysts of Examples 1 to 6, when Mg was contained, acid sites which serve as adsorption sites of water in the zeolite were protected, and dealumination was prevented and accordingly structural stability was improved. In addition, when the SAR and the content of Mg were set to be in a predetermined range, NOx removal performance was optimized while sufficient structural stability was maintained.

What is claimed is:

1. An SCR catalytic system comprising:
an SCR catalyst which is a Cu- and Mg-containing CHA zeolite in which a molar ratio of SiO₂ with respect to Al₂O₃ is 10 to 13 and 0.18 weight % to 0.44 weight % of Mg is contained, and which absorbs NH₃ and reduces NOx using the absorbed NH₃ as a reducing agent.

2. The SCR catalytic system according to claim 1, wherein NH₃ generated when fuel is temporarily injected into an engine such that a combustion state of the engine becomes a rich state is used as a reducing agent of the SCR catalyst.
